(19) United States
(12) Patent Application Publication
(10) Pub. No.: US 2005/0251756 A1
(43) Pub. Date: Nov. 10, 2005

(54) User support system and method, and computer-readable storage medium

(75) Inventor: Kenichi Tamaki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/180,864

(22) Filed: Jul. 14, 2005

Related U.S. Application Data
(63) Continuation of application No. PCT/JP03/06017, filed on May 14, 2003.

(51) Int. Cl. G06F 3/00

(52) U.S. Cl. 715/805

(57) ABSTRACT

A user support system is provided with a receiving part including a plurality of user support windows that receive first image data showing a state of trouble generated in an information processing apparatus, from an electronic apparatus that is independent of the information processing apparatus, and a sending part that sends second image data showing a procedure for solving the trouble, to the electronic apparatus.

### BACKGROUND OF THE INVENTION

This application is a continuation application filed under 35 U.S.C. 111(a) claiming the benefit under 35 U.S.C. 120 and 365(c) of a PCT International Application No.PCT/JP2003/006017 filed May 14, 2003, in the Japanese Patent Office, the disclosure of which is hereby incorporated by reference.

1. Field of the Invention

The present invention generally relates to user support systems and methods and computer-readable storage media, and more particularly to a user support system and a user support method which provides a user support with respect to an information processing apparatus such as a personal computer, using image data. The present invention also relates to computer-readable storage medium which stores a user support program that causes a computer to provide such a user support.

The user of the information processing apparatus, such as the personal computer, can receive expert support by utilizing a user support system that is provided by a manufacturer or the like of the information processing apparatus. The user support is utilized in situations such as when the user wishes to know how to operate the information processing apparatus in order to perform a certain task or the information processing apparatus does not seem to operate correctly.

2. Description of the Related Art

The user support system can roughly divided into 3 kinds, namely, a telephone support system, an electronic mail support system and a software support system. The 3 kinds of support systems are utilized depending on the user's needs.

The telephone support system provides the user support using the telephone. Normally, when the user make a telephone call to a user support center, a system of the user support center automatically connects the call to a user support window that is in a standby state. When the connection between the user and the user support window is established, the user support window specifies the calling user by confirming the user based on the name, a user registration number and the like of the user. Some user support systems acquire the telephone number of the calling user, and automatically specifies the user by referring to a personal information database related to users. Personal information of the user, support logs and the like are displayed at the user support window. According to the telephone support system, a support person (operator) at the user support window finds out the trouble encountered by the user or the question of the user through conversation made between the user and the user support window, and provides appropriate advices to the user.

The electronic mail support system provides the user support using the Internet. It is expensive to have the support person in the standby as in the case of the telephone support system. On the other hand, in the electronic mail support system, it is possible to provide the user support using the electronic mail, even in a time band, such as late at night, when the support person is absent. The utilization of the electronic mail support system is becoming more popular due to the popularization of the Internet. The user writes the contents of the specific questions in the electronic mail, and sends the electronic mail to the user support window of the user support center. Thereafter, the replies or answers to the contents of the questions are received by an electronic mail from the user support window. Normally, the electronic mail that is returned from the user support window is a one-way transmission from the user support window to the user, and the user cannot return another electronic mail with respect to the electronic mail that is received from the user support window.

The software support system uses a support tool that is embedded in advance in the user's personal computer, for example. The user support is made by operating the user's personal computer from the user support window (or the user support center) via the Internet or a telephone line or, the user support is made by displaying a state of the user's personal computer on a display at the user support window. Normally, the software support system is used together with the telephone support system. If the user is unfamiliar with computer-related terminologies, the user cannot describe the cause of the trouble using appropriate terminologies, thereby taking time for the user support window to find out the cause of the trouble. But when the support tool is embedded in advance in the user's personal computer, the user support window can find out the specific cause of the trouble using the support tool and provide an appropriate user support.

In the case of the telephone support system, if the calling user is unfamiliar with the computer-related terminologies, there were problems in that it takes time for the user support window to find out the cause of the trouble and that it is difficult for the user support window to provide an appropriate advice to the user.

In addition, in the case of the electronic mail system, the reply or answer to the contents of the question from the user is made by the electronic mail from the user support window after a predetermined time from the time when the contents of the question are received by the electronic mail from the user. Hence, there was a problem in that it is impossible to provide a real-time user support. Furthermore, in a case where the user's personal computer does not operate normally, there was a problem in that the contents of the question cannot be sent from the personal computer by the electronic mail to the user support center.

Accordingly, it may be regarded that the quality of the user support will be improved by the simultaneous use of the telephone support system and the software support system, but there is a problem in that the utilization range of the software support system is limited. For example, if the user support is made by using the support toll that is installed in the personal computer in which the trouble is generated, the personal computer may not operate correctly depending on the trouble. In addition, in the case of a hardware trouble of the personal computer, the support tool that is installed in the personal computer, in many cases, cannot cope with the trouble. Moreover, if the support tool is not correctly installed (set) in the personal computer, an appropriate user support cannot be made. But on the other hand, if the user had computer-related knowledge sufficient to correctly install (set) the support tool in the personal computer, this user would originally not require the user support.

Even if a procedure for solving the trouble is provided from the user support window, there are cases where the problem solving procedure cannot be understood by the user if this user does not have sufficient computer-related knowledge. In such a case, the user support window will have to provide a procedure for carrying out a recovery process with respect to the personal computer, and as a result, an excessively large burden is placed on the user.

The applicant is aware of the following prior art.

Japanese Laid-Open Patent Application No. 2002-152453

Japanese Laid-Open Patent Application No. 2002-24291

Japanese Laid-Open Patent Application No. 10-260916

Japanese Laid-Open Patent Application No. 2002-269249

Japanese Laid-Open Patent Application No. 2002-82883

Japanese Laid-Open Patent Application No. 2001-202451

### SUMMARY OF THE INVENTION

Accordingly, it is a general object of the present invention to provide a novel and useful user support system and method and computer-readable storage medium, in which the problems described above are suppressed.

Another and more specific object of the present invention is to provide a user support system and method and computer-readable storage medium, which advise a state of a trouble to a user support window by a means that is independent of an information processing apparatus in which the trouble is generated. According to the present invention, the user support is made in cooperation with an electronic apparatus with a camera, such as a portable telephone set with a camera, and for this reason, it is possible to accurately and quickly find out the state of the trouble at the user support window, regardless of a degree of computer-related knowledge of the user.

Another and more specific object of the present invention is to provide a user support system and method and computer-readable storage medium, which advise a procedure for solving a trouble to the user by a means that is independent of an information processing apparatus in which the trouble is generated. According to the present invention, the user support is made in cooperation with an electronic apparatus with a camera, such as a portable telephone set with a camera, and for this reason, it is possible to quickly advise the procedure for solving the trouble in an easily understandable manner, regardless of a degree of computer-related knowledge of the user.

Still another object of the present invention is to provide a user support system comprising a receiving part including a plurality of user support windows configured to receive first image data showing a state of trouble generated in an information processing apparatus, from an electronic apparatus that is independent of the information processing apparatus; and a sending part configured to send second image data showing a procedure for solving the trouble, to the electronic apparatus. According to the user support system of the present invention, it is possible to improve the user support because the state of the trouble can be informed to the user support window and the procedure for solving the trouble can be informed to the user by a means that is independent of the information processing apparatus in which the trouble is generated.

A further object of the present invention is to provide a user support method comprising a receiving step receiving, by one of a plurality of user support windows, first image data showing a state of a trouble generated in an information processing apparatus, from an electronic apparatus that is independent of the information processing apparatus; and a sending step sending, from the one of the plurality of user support windows, second image data showing a procedure for solving the trouble, to the electronic apparatus. According to the user support method of the present invention, it is possible to improve the user support because the state of the trouble can be informed to the user support window and the procedure for solving the trouble can be informed to the user by a means that is independent of the information processing apparatus in which the trouble is generated.

Another object of the present invention is to provide a computer-readable storage medium which stores a program for causing a computer to provide a user support via a plurality of user support windows, the program comprising a receiving procedure causing the computer to receive, by one of the plurality of user support windows, first image data showing a state of trouble generated in an information processing apparatus, from an electronic apparatus that is independent of the information processing apparatus; and a sending procedure causing the computer to send, from the one of the plurality of user support windows, second image data showing a procedure for solving the trouble, to the electronic apparatus. According to the computer-readable storage medium of the present invention, it is possible to improve the user support because the state of the trouble can be informed to the user support window and the procedure for solving the trouble can be informed to the user by a means that is independent of the information processing apparatus in which the trouble is generated.

Other objects and further features of the present invention will be apparent from the following detailed description when read in conjunction with the accompanying drawings.

### BRIEF DESCRIPTION OF THE DRAWINGS

FIG. 1 is a system block diagram showing a structure of an embodiment of a user support system according to the present invention;

FIG. 2 is a perspective view showing a personal computer;

FIG. 3 is a system block diagram showing a structure of an important part of the personal computer;

FIG. 4 is a flow chart for explaining an operation of the embodiment of the user support system;

FIG. 5 is a flow chart for explaining the operation of the embodiment of the user support system;

FIG. 6 is a flow chart for explaining the operation of the embodiment of the user support system;

FIG. 7 is a flow chart for explaining the operation of the embodiment of the user support system;

FIG. 8 is a flow chart for explaining the operation of the embodiment of the user support system;

FIG. 9 is a flow chart for explaining the operation of the embodiment of the user support system;

FIG. 10 is a flow chart for explaining the operation of the embodiment of the user support system;

FIG. 11 is a flow chart for explaining the operation of the embodiment of the user support system;

FIG. 12 is a flow chart for explaining the operation of the embodiment of the user support system;

FIG. 13 is a diagram showing information stored in a user registration database;

FIG. 14 is a diagram for explaining tables storing information of the user registration database;

FIG. 15 is a diagram showing a database with an image conversion engine; and

FIG. 16 is a diagram for explaining tables for storing information of the database with the image conversion engine.

### DESCRIPTION OF THE PREFERRED EMBODIMENTS

A description will be given of embodiments of a user support system and method and computer-readable storage medium according to the present invention, by referring to the drawings.

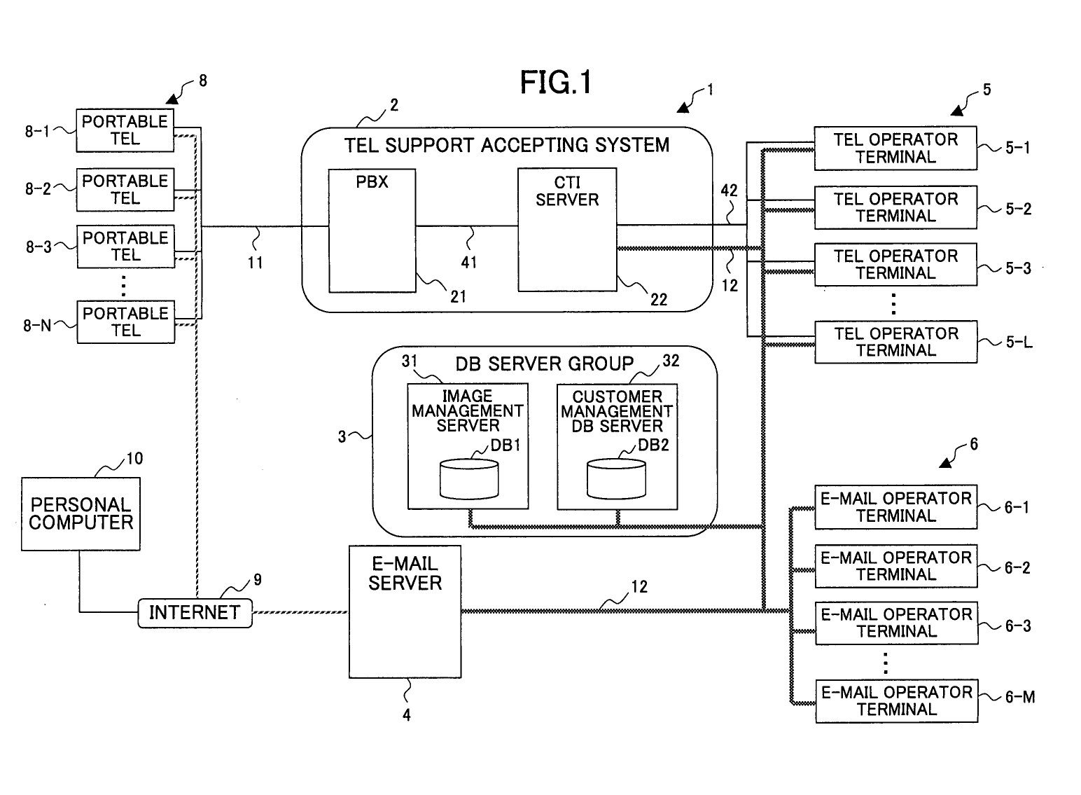

FIG. 1 is a system block diagram showing a structure of an embodiment of the user support system according to the present invention. This embodiment of the user support system employs an embodiment of a user support method according to the present invention and an embodiment of a computer-readable storage medium according to the present invention. The computer-readable storage medium stores a computer program for causing a computer to carry out the user support, and may be formed by any suitable recording medium capable of storing the computer program in a computer-readable manner. Further, the computer program may be obtained via a transmission medium.

A user support center 1 of the user support system includes a telephone support accepting system 2, a database (DB) server group 3, an electronic mail (hereinafter simply referred to as an e-mail) server (mail receiving system) 4, a telephone operator terminal group 5, and an e-mail operator terminal group 6. The telephone support accepting system 2 is connectable to a portable telephone group 8 via a telephone line public network 11. The e-mail server 4 is connectable to the portable telephone group 8 and a personal computer 10 via the Internet 9. The portable telephone group 8 is made up of portable telephones 8-1 through 8-N of a plurality of users, where N is an arbitrary integer. The portable telephones 8-1 through 8-N have a known structure with a camera, and include a telephone function for making a communication by telephone, an e-mail function for making a communication by e-mail, and an image pickup function for picking up an image by the camera. The image that is picked up by the camera includes still images and/or dynamic images. For the sake of convenience, it is assumed that the personal computer 10 is an information processing apparatus that is used by the user and for which the user can receive the user support from the user support center 1.

The telephone support accepting system 2 includes a telephone exchange (PBX) 21 and a computer telephone integration (CTI) server 22 that are connected via a telephone line or LAN 41. The telephone exchange 21 is connectable to the portable telephone group 8 via the telephone line public network 11. The CTI server 22 is connectable to telephone operator terminals 5-1 through 5-L of the telephone operator terminal group 5 via a telephone network 42, where L is an arbitrary integer.

The database server group 3 includes an image management server 31 for managing an image database (or an image database with an image conversion engine) DB1 of images including dynamic images, and a customer management database server 32 for managing a user registration database DB2. Databases such as the image database DB1 and the user registration database DB2 may be provided within the database server group 3 or, provided externally to the database server group 3.

The e-mail server 4 is connected to the Internet 9 on one hand, and connected via a LAN 12 to the CTI server 22 of the telephone support accepting system 2, the image management server 31 and the customer management database server 32 of the database server group 3, the telephone operator terminals 5-1 through 5-L of the telephone operator terminal group 5, and e-mail operator terminals 6-1 through 6-M of the e-mail operator terminal group 6, where M is an arbitrary integer.

Each of the CTI server 22, the image management server 31, the customer management database server 32 and the e-mail server 4 may be formed by a general-purpose computer having a known structure including a processor such as a CPU, a storage unit and the like. In addition, each of the telephone operator terminals 5-1 through 5-L of the telephone operator terminal group 5 and the e-mail operator terminals 6-1 through 6-M of the e-mail operator terminal group 6 may be formed by a personal computer having a known structure including a processor such as a CPU, a storage unit and the like. The personal computer used in this case may basically have a structure identical to that of the personal computer 10. Each of the telephone operator terminals 5-1 through 5-L includes a telephone function for making a communication by telephone, and an e-mail function for making a communication by e-mail. Each of the e-mail operator terminals 6-1 through 6-M similarly includes a telephone function for making a communication by telephone, and an e-mail function for making a communication by e-mail.

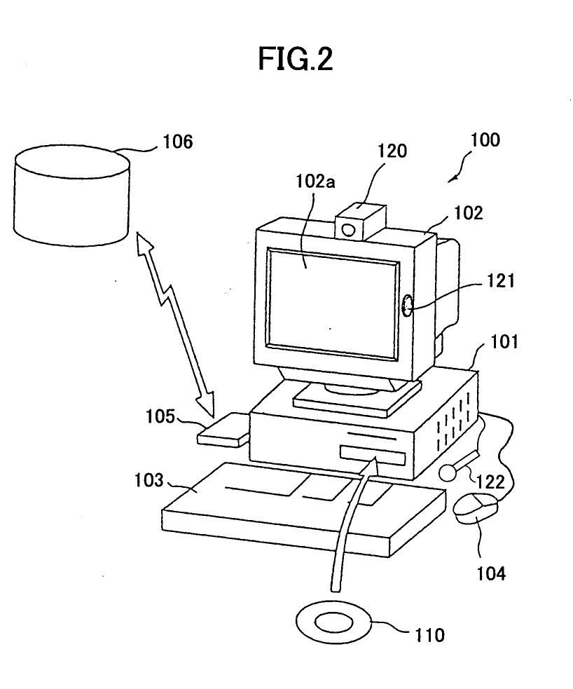

FIG. 2 is a perspective view showing a personal computer. A personal computer 100 shown in FIG. 2 includes a main body part 101, a display 102, a keyboard 103, a mouse 104, a modem 105, a camera 120, a speaker 121 and a microphone 122. The main body part 101 includes a CPU, a disk drive and the like. The display displays an image on a display screen 102a in response to an instruction from the main body part 101. The keyboard 103 is used to input various information to the personal computer 100. The mouse 104 is used to specify an arbitrary position on the display screen 102a of the display 102. The modem 105 makes access to an external database or the like and downloads a computer program and the like that are stored in another computer. A computer program that is stored in a portable recording medium such as a disk 110 or, downloaded from a recording medium 106 of another computer using a communication unit such as the modem 105, is input to the personal computer 100 and executed.

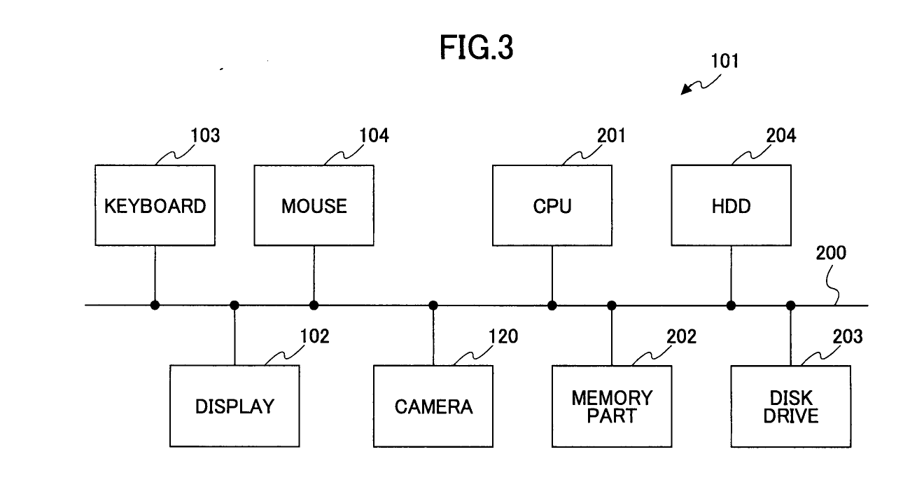

FIG. 3 is a system block diagram showing a structure of an important part of the personal computer 100. The main body part 101 includes a CPU 201, a memory part 202 including a RAM, a ROM or the like, a disk drive 203 for the disk 110, and a hard disk drive (HDD) 204 that are connected via a bus 200. In this embodiment, it is assumed for the sake of convenience that the display 102, the keyboard 102, the mouse 104, the camera 120, the speaker 121 (not shown in FIG. 3) and the microphone 122 (not shown in FIG. 3) are also connected to the bus 200, however, these elements may of course be connected directly to the CPU 201.

When using the personal computer 100 as the telephone operator terminals 5-1 through 5-L of the telephone operator terminal group 5 or the e-mail operator terminals 6-1 through 6-M of the e-mail operator terminal group 6, the camera 120 may be omitted. In addition, the speaker 121 and the microphone 122 may be provided in a headset used by the operator and having a known structure. Furthermore, when using the personal computer 100 as the personal computer 10, the camera 120, the speaker 121 and the microphone 122 may be omitted.

In this embodiment, it is assumed that a trouble is generated in the personal computer 10 of the user, and that the user uses the portable telephone 8-1 to receive the user support from the user support center 1. The trouble may be caused by an abnormality generated in the personal computer 10 or, caused by the user's lack of knowledge regarding the operation of the personal computer 10. The telephone operator terminals 5-1 through 5-L of the telephone operator terminal group 5 and the e-mail operator terminals 6-1 through 6-M of the e-mail operator terminal group 6 correspond to a user support window.

Since the portable telephone 8-1 is provided with the camera, the screen of the personal computer 10, the procedure up to when the trouble is generated and the like can be picked up as a dynamic image by the camera and sent via e-mail to the user support window of he user support center 1. Hence, the user support window can immediately and accurately find out the state of the trouble generated in the personal computer 10. Information (screen) related to the trouble of the personal computer 10 is sent to the user support window from the portable telephone 8-1, and not from the personal computer 10, thereby making it possible to accurately and quickly send the state of the trouble to the user support center 1, independently of (that is, without being affected by) the state of the trouble in the personal computer 10.

At the same time, the portable telephone 8-1 that is provided with the camera normally has a display screen for displaying contents of the picked up images. Hence, by displaying on the display screen of the portable telephone 8-1, from the user support window of the user support center 1, an image data including a dynamic image data showing a method of coping with the trouble generated in the personal computer 10 in an easily understandable manner, the user can easily solve the problem by following the displayed method. For example, the user support window obtains an image file including a dynamic image file that illustrates a procedure for coping with (that is, for eliminating) the trouble, from the image database DB1 including the dynamic image file, and sends the image file to the portable telephone 8-1 of the user by attaching the image file to the electronic mail, so as to display the image file on the display screen of the portable telephone 8-1. A display performance of the display screen of the portable telephone 8-1 depends on the model of the portable telephone 8-1. For this reason, in order to make an optimum display for the model, it is desirable to provide a function of automatically processing (converting) the image data into an appropriate format when obtaining the image data from the image database DB1, as will be described later.

Therefore, the user support window can accurately and quickly find out the state of the trouble generated in the personal computer 10, regardless of the state of the trouble in the personal computer 10. In addition, the user can easily solve the trouble by referring to the image data that is displayed on the display screen of the portable telephone 8-1 and includes the dynamic image showing the method of coping with the trouble in an easily understandable manner. Consequently, it is possible to reduce the time that is required to provide the user support, and to provide a user support that more fully responds to the customer's demands.

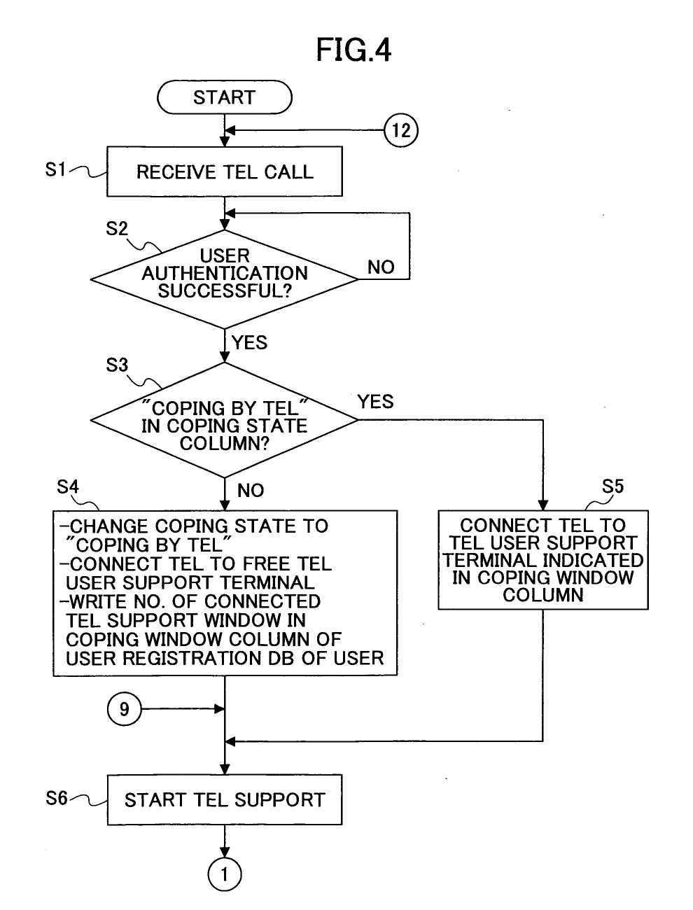

Next, a description will be given of the operation of this embodiment, by referring to FIGS. 4 through 12. FIGS. 4 through 12 are flow charts for explaining the operation of this embodiment. In the following description, it is assumed that the image management server 31 manages the database DB1 provided with an image conversion engine.

The process shown in FIG. 4 is started when a trouble is generated in the personal computer 10 and the user of the personal computer 10 makes a telephone call from the portable telephone 8-1, for example, to the user support center 1. In a step S1, the CTI server 22 of the telephone support accepting system 2 receives the telephone call from the portable telephone 8-1 of the user via the telephone exchange 21. In a step S2, the CTI server 22 makes access to the user registration database DB2 via the customer management database server 32 of the database server group 3 to authenticate the user by a known method (that is, confirm that the user is the person himself), and decides whether or not the authentication is possible and the user can be specified. If the decision result in the step S2 is YES, a step S3 decides whether or not “coping by telephone (in progress)” is stored in a coping state column of the user registration database DB2 with respect to the specified user.

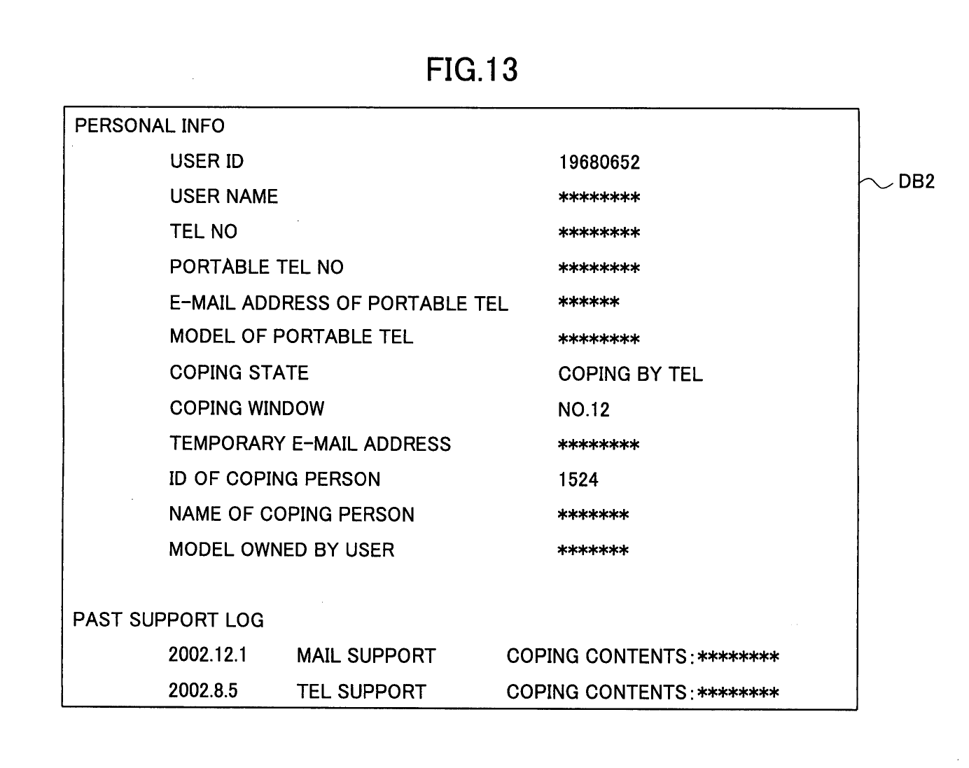

FIG. 13 is a diagram showing information (user data) stored in the user registration database DB2. At each operator terminal of the telephone operator terminal group 5 or the e-mail operator terminal group 6, it is possible to display the user registration database DB2 in the format shown in FIG. 13. As shown in FIG. 13, the user registration database DB2 stores personal information and a past support log. The personal information includes a user ID, user name, telephone number, portable telephone number, e-mail address of portable telephone, model (or kind or type) of portable telephone, coping state, coping window, temporary e-mail address, ID of coping person, name of coping person, model of personal computer owned by user, and the like. On the other hand, the past support log includes a date when a user support was made, a user support method (or support type) such as the e-mail support and the telephone support, coping contents of the user support, and the like. For example, FIG. 13 shows a case where the user ID is “19680652”, the coping state is “coping by telephone”, the coping window is “No. 12”, and the ID of the coping person is “1524”.

In a case where the connection of the portable telephone 8-1 to the telephone line for receiving the telephone support from the user support center 1 is once disconnected in order to transmit and receive the e-mail, status information “coping by telephone” is stored in the coping state column. When the coping state column is “coping by telephone”, an address of the telephone operator terminal that is coping with the user by the telephone (for example, an address “12” of the telephone operator terminal 5-12) is stored in a coping window column. When the coping state column is “coping by telephone” and a temporary e-mail address TMA is generated, the address of the telephone operator terminal that is coping with the user by the telephone (for example, the address “12” of the telephone operator terminal 5-12) is stored in the coping window column, and the temporary e-mail address TMA generated by this telephone operator terminal is stored in a temporary e-mail address column. When the telephone operator terminal that is coping with the user by the telephone (for example, the telephone operator terminal 5-12) generates the temporary e-mail address TMA, the temporary e-mail address TMA is stored in the temporary e-mail address column.

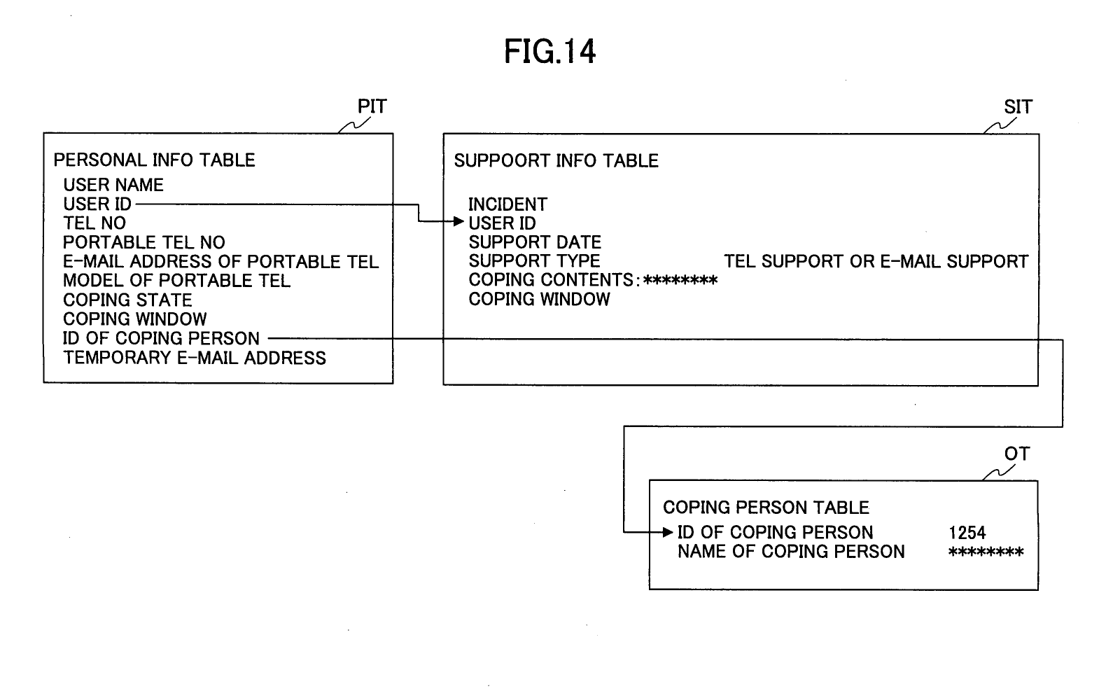

FIG. 14 is a diagram for explaining tables storing the information of the user registration database DB2. FIG. 14 shows a personal information table PIT, a past support information table SIT, and a coping person table OT. The personal information table PIT includes a user name, user ID, telephone number, portable telephone number, e-mail address of portable telephone, model (or kind or type) of portable telephone, coping state, coping window, ID of coping person, temporary e-mail address and the like. The past support information table SIT includes an incident, user ID, support date, support type, coping contents, coping window and the like. The coping person table OT includes an ID of coping person, name of coping person and the like. The user registration database DB2 stores the contents of the personal information table PIT, the past support information table SIT and the coping person table OT in a linked manner as indicated by arrows in FIG. 14.

In the steps S1 and S2, the CTI server 22 of the telephone support accepting system 2 carries out the user authentication based on the telephone call from the portable telephone 8-1 of the user. However, the user authentication is not limited to that using the telephone. For example, when the user utilizes a Web e-mail distribution system or an on-line chat service, the following steps S1-1 and S2-1 may be carried out in place of the steps S1 and S2. In this case, in the step S1-1, the e-mail server 4 receives a log-in to the Web e-mail distribution system using the portable telephone 8-1 of the user. In addition, in the step S1-2, the e-mail server 4 decides whether or not the log-in to the Web e-mail distribution system was successful, and the process returns to the step S1-1 if the decision result in the step S1-2 is NO, while the process advances to the step S3 shown in FIG. 4 if the decision result in the step S1-2 is YES. When the log-in is made to the Web e-mail distribution system, user authentication information is input at the time of the log-in, and thus, the reference to the user registration database DB2 in the step S3 and the subsequent steps can be made based on this user authentication information.

Returning now to the description of FIG. 4, if the decision result in the step S3 is NO, a step S4 carries out the following processes ST1 through ST3.

ST1: The coping state column of the user registration database DB2 with respect to the specified user is changed to “coping by telephone”.

ST2: The telephone call from the portable telephone 8-1 is connected to one of the telephone operator terminals 5-1 through 5-L of the telephone operator terminal group 5 that is free or not busy (that is, not “coping by telephone”) at that point in time.

ST3: The window number of the telephone operator terminal to which the telephone call from the portable telephone 8-1 is connected is stored in the coping window column of the user registration database DB2.

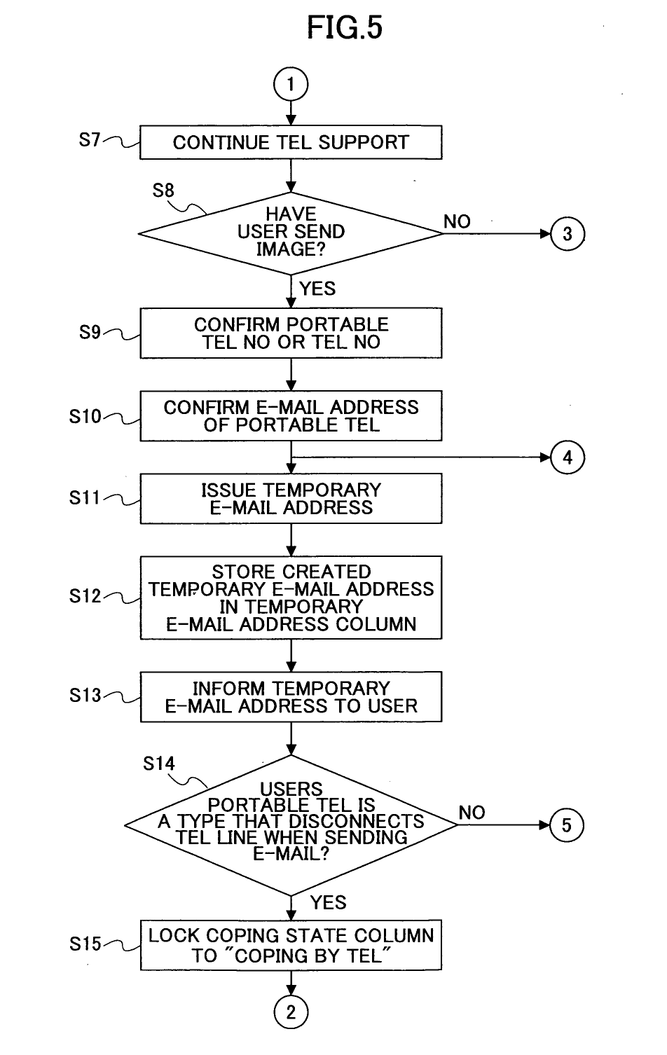

On the other hand, if the decision result in the step S3 is YES, the process advances to a step S5. In the step S5, the CTI server 22 refers to the coping window column of the user registration database DB2 with respect to the user, via the customer management database server 32, and connects the portable telephone 8-1 to the telephone operator terminal having the window number that is stored in the coping window column. After the step S4 or S5, the process advances to a step S6. In the step S6, the telephone support is started under the control of the CTI server 22, and the process advances to a step S7 shown in FIG. 5.

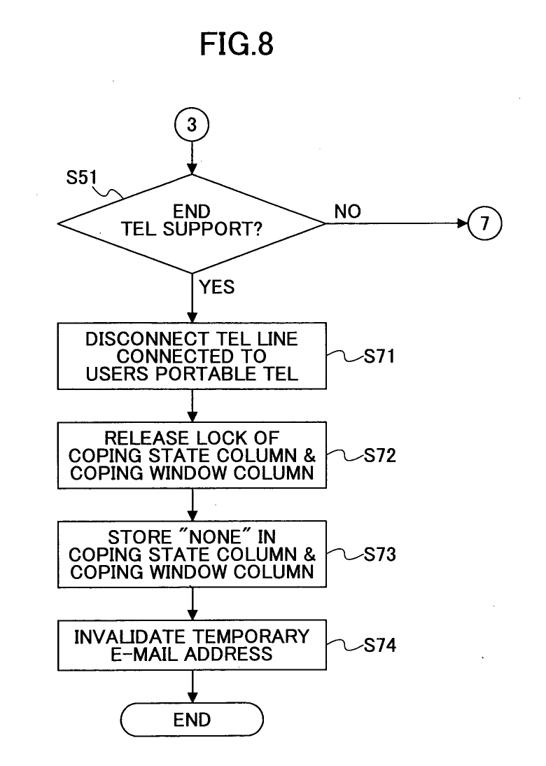

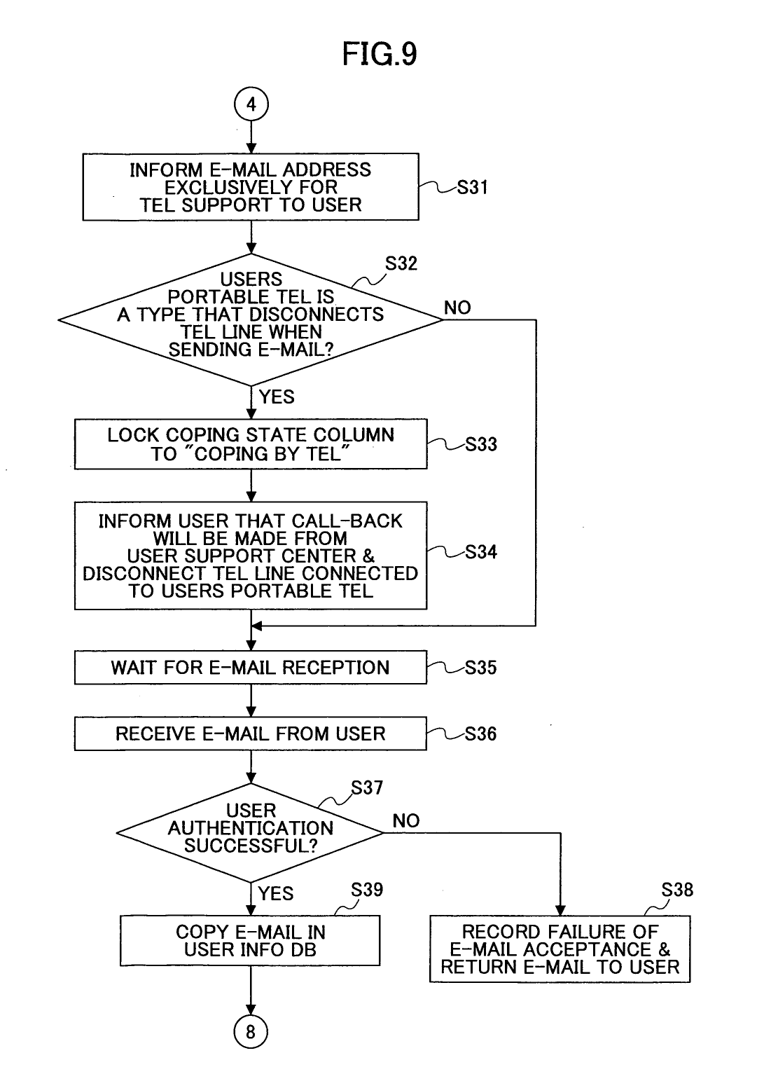

In the step S7 shown in FIG. 5, the telephone support is continued under the control of the CTI server 22. A step S8 decides whether or not an operator (support person) of the telephone operator terminal 5-12 that is coping with the user is to have the user send the image data by e-mail from the portable telephone 8-1 of the user, based on the contents and the like of the conversation with the user. If the decision result in the step S8 is NO, the process advances to a step S51 shown in FIG. 8 which will be described later. If the decision result in the step S8 is YES, the process advances to a step S9. In the step S9, the operator of the telephone operator terminal 5-12 confirms the portable telephone number column or the telephone number column of the user registration database DB2 with respect to the user, because the operator of the telephone operator terminal 5-12 may in some cases call back the user. In addition, in a step S10, the operator of the telephone operator terminal 5-12 confirms the e-mail address of the portable telephone column of the user registration database DB2 with respect to the user. After the step S10, the process advances to a first process pattern starting from a step S11 or, to a second process pattern starting from a step S31 shown in FIG. 9 which will be described later. The first or second process pattern may be selected by the operator of the telephone operator terminal 5-12 or, selected depending on a request from the user. Furthermore, one of the first and second process patterns may be selected by the user support center 1 depending on a time band and the like, for example.

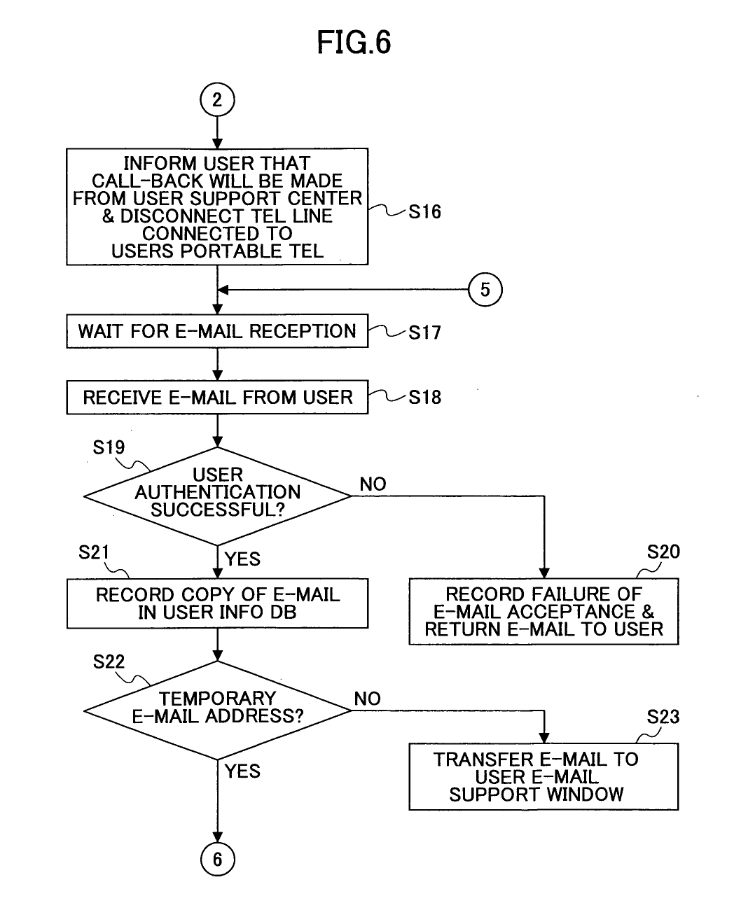

In the case of the first process pattern, the telephone operator terminal 5-12 issues a temporary e-mail address in the step S11. In the step S12, the issued temporary e-mail address in the temporary e-mail address column of the user registration database DB2 with respect to the user, under the control of the customer management database server 32. In a step S13, the operator of the telephone operator terminal 5-12 informs the temporary e-mail address to the portable telephone 8-1 of the user. In a step S14, the operator of the telephone operator terminal 5-12 confirms the portable telephone model column of the user registration database DB2 with respect to the user, and decides whether or not the portable telephone 8-1 is a type which disconnects the connected telephone line when sending the e-mail. If the decision result in the step S14 is NO, the process advances to a step S17 shown in FIG. 6 which will be described later. On the other hand, if the decision result in the step S14 is YES, the process advances to a step S15. In the step S15, the operator of the telephone operator terminal 5-12 locks the coping state column of the user registration database DB2 with respect to the user to “coping by telephone”, and the process advances to a step S16 shown in FIG. 6.

The steps S9, S10, S14 and S15 may be carried out automatically by the telephone operator terminal 5-12 under the control of the customer management database server 32.

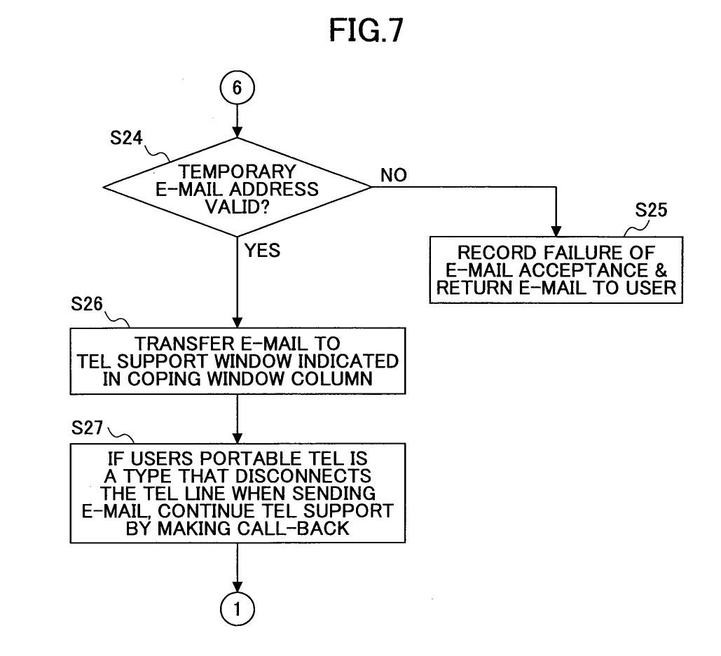

In the step S16 shown in FIG. 6, the operator of the telephone operator terminal 5-12 informs the portable telephone 8-1 of the user that a call-back will be made to the user from the user support center 1 after receiving the e-mail from the user, and disconnects the telephone line that is connected to the portable telephone 8-1 of the user. In a step S17, the e-mail server 4 waits for the e-mail from the user. In a step S18, the e-mail server 4 receives the e-mail from the portable telephone 8-1 of the user via the Internet 9. In a step S19, the e-mail server 4 makes access to the user registration database DB2 via the customer management database server 32 based on a sender address of the received e-mail to authenticate the user by a known method (that is, confirm that the user is the person himself), and decides whether or not the authentication is possible and the user can be specified. If the decision result in the step S19 is NO, the e-mail server 4 records a failure of the e-mail acceptance and returns an e-mail to the user, in a step S20. On the other hand, if the decision result in the step S19 is YES, the e-mail server 4 records a copy of the received e-mail in the user registration database DB2 via the customer management database server 32, in a step S21. In a step S22, the e-mail server 4 checks the destination address of the received e-mail, and decides whether or not the destination address is the temporary e-mail address. If the decision result in the step S22 is NO, the e-mail server 4 transfers the received e-mail to a corresponding e-mail operator terminal (for example, the e-mail operator terminal 6-3) of the e-mail operator terminal group 6, in a step S23. On the other hand, if the decision result in the step S22 is YES, the process advances to a step S24 shown in FIG. 7.

In the step S24 shown in FIG. 7, the e-mail server 4 makes access to the user registration database DB2 via the customer management database server 32 to decide whether or not the temporary e-mail address is valid. If the decision result in the step S24 is NO, the e-mail server 4 records a failure of the e-mail acceptance and returns an e-mail to the user, in a step S25. On the other hand, if the decision result in the step S24 is YES, the e-mail server 4 transfers the received e-mail to the telephone operator terminal having the number (address) stored in the coping window column of the user registration database DB2 with respect to the user, in a step S26. In this particular case, the e-mail is transferred to the telephone operator terminal 5-12 having the number “12”. In a step S27, if the operator of the telephone operator terminal 5-12 confirms from the user registration database DB2 with respect to the user that the portable telephone 8-1 is a type which disconnects the connected telephone line when sending the e-mail, a call-back is made from the user support center 1 with respect to the portable telephone 8-1 to continue the telephone support. More particularly, the process returns to the step S7 shown in FIG. 5 after the step S27.

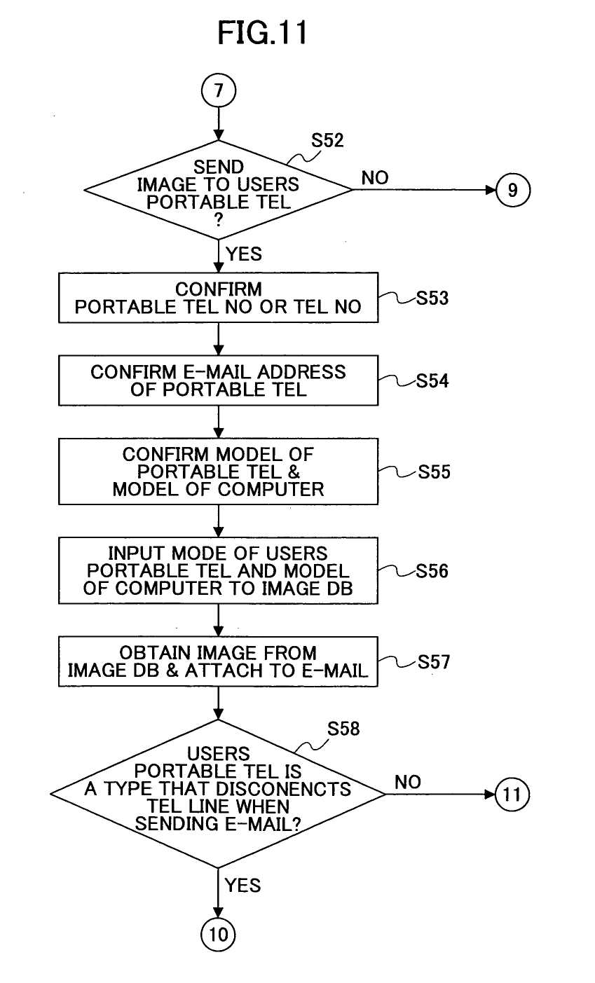

As described above, the step S51 shown in FIG. 8 is carried out if the decision result in the step S8 shown in FIG. 5 is NO. In the step S51, the operator of the telephone operator terminal 5-12 decides whether or not to end the telephone support with respect to the user, based on the contents and the like of the conversation with the user. If the decision result in the step S51 is NO, the process advances to a step S52 shown in FIG. 11 which will be described later. On the other hand, if the decision result in the step S51 is YES, the operator of the telephone operator terminal 5-12 disconnects the telephone line connected to the portable telephone 8-1 of the user, in a step S71. In a step S72, the operator of the telephone operator terminal 5-12 releases (or cancels) the lock of the coping state column and the coping window column of the user registration database DB2 with respect to the user. In a step S73, the operator of the telephone operator terminal 5-12 stores “none” in the coping state column and the coping window column of the user registration database DB2 with respect to the user. Further, in a step S74, the operator of the telephone operator terminal 5-12 invalidates the temporary e-mail address, and the process ends.

The steps S72 through 74 may be carried out automatically by the telephone operator terminal 5-12 under the control of the customer management database server 32.

As described above, the step S31 shown in FIG. 9 is carried out in the case of the second processing pattern. In the step S31, the operator of the telephone operator terminal 5-12 informs an e-mail address exclusively for the telephone support to the portable telephone 8-1 of the user. In a step S32, the operator of the telephone operator terminal 5-12 confirms the portable telephone model column of the user registration database DB2 with respect to the user, and decides whether or not the portable telephone 8-1 is a type which disconnects the connected telephone line when sending the e-mail. If the decision result in the step S32 is NO, the process advances to a step S35 which will be described later. On the other hand, if the decision result in the step S32 is YES, the process advances to a step S44. In the step S33, the operator of the telephone operator terminal 5-12 locks the coping state column of the user registration database DB2 with respect to the user to “coping by telephone”.

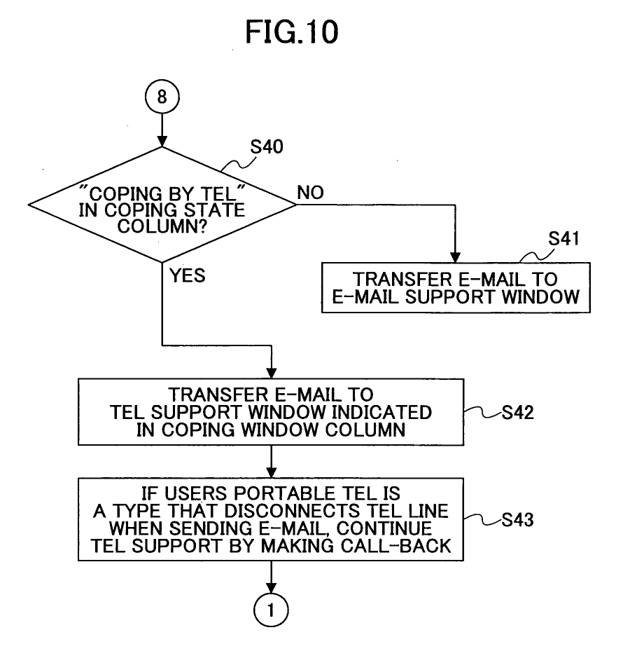

In a step S34, the operator of the telephone operator terminal 5-12 informs the portable telephone 8-1 of the user that a call-back will be made from the user support center 1 after receiving the e-mail from the user, and disconnects the telephone line connected to the portable telephone 8-1 of the user. In the step S35, the e-mail server 4 waits for the e-mail from the user, and in a step S36, the e-mail server 4 receives the e-mail from the portable telephone 8-1 of the user via the Internet 9. In a step S37, the e-mail server 4 makes access to the user registration database DB2 via the customer management database server 32 to authenticate the user by a known method (that is, confirm that the user is the person himself), and decides whether or not the authentication is possible and the user can be specified. If the decision result in the step S37 is NO, the process advances to a step S38. In the step S38, the e-mail server 4 records a failure of the e-mail acceptance and returns an e-mail to the user. On the other hand, if the decision result in the step S37 is YES, the e-mail server 4 records a copy of the received e-mail in the user registration database DB2 via the customer management database server 32, in a step S39, and the process advances to a step S40 shown in FIG. 10.

The steps S32 through 34 may be carried out automatically by the telephone operator terminal 5-12 under the control of the customer management database server 32.

In the step S40 shown in FIG. 10, the e-mail server 4 access the user registration database DB2 via the customer management database server 32, and decides whether or not “coping by telephone” is stored in the coping column. If the decision result in the step S40 is NO, the e-mail server 4 transfer the received e-mail to a corresponding e-mail operator terminal (for example, the e-mail operator terminal 6-3) of the e-mail operator terminal group 6, in a step S41. On the other hand, if the decision result in the step S40 is YES, the e-mail server 4 transfers the received e-mail to the telephone operator terminal having a number (address) stored in the coping window column of the user registration database DB2 with respect to the user, in a step S42. In this particular case, the e-mail is transferred to the telephone operator terminal 5-12 having the number “12”. In a step S43, if the operator of the telephone operator terminal 5-12 confirms from the user registration database DB2 with respect to the user that the portable telephone 8-1 is a type which disconnects the connected telephone line when sending the e-mail, a call-back is made with respect to the portable telephone 8-1 from the user support center 1, so as to continue the telephone support. More particularly, the process returns to the step S7 shown in FIG. 5 after the step S43.

As described above, the step S52 shown in FIG. 11 is carried out if the decision result in the step S51 shown in FIG. 8 is NO. In the step S52, the operator of the telephone operator terminal 5-12 decides, based on the contents and the like of the conversation with the user, whether or not to send to the portable telephone 8-1 of the user the image data showing the method of coping with the trouble in the easily understandable manner. If the decision result in the step S52 is NO, the process returns to the step S6 shown in FIG. 4. On the other hand, if the decision result in the step S52 is YES, the operator of the telephone operator terminal 5-12 confirms the portable telephone number column or the telephone number column of the user registration database DB2 with respect to the user, in a step S53, because the operator of the telephone operator terminal 5-12 may in some cases call back the user. In addition, in a step S54, the operator of the telephone operator terminal 5-12 confirms the portable telephone e-mail address column of the user registration database DB2 with respect to the user.

In a step S55, the operator of the telephone operator terminal 5-12 confirms the portable telephone model column and the personal computer model column (column of the model of the personal computer owned by the user) of the user registration database DB2 with respect to the user. In a step S56, the operator of the telephone operator terminal 5-12 inputs, via the image management server 31, the portable telephone model of the user (model of the user's portable telephone) and the personal computer model (model of the user's personal computer) with respect to the database DB1 with the image conversion engine. In a step S57, the operator of the telephone operator terminal 5-12 obtains the image data for the input personal computer model, showing the method of coping with the trouble in the easily understandable manner, with an appropriate format, such as the image size and the resolution, that conforms to (or suits) the input portable telephone model, and attaches the image data to the e-mail that is to be sent to the user.

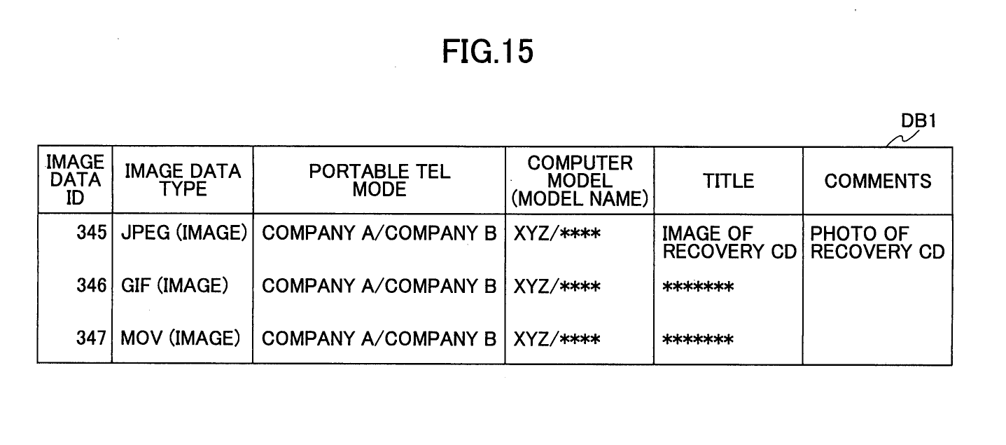

FIG. 15 shows the database DB1 with the image conversion engine. At each operator terminal of the telephone operator terminal group 5 or the e-mail operator terminal group 6, the database DB1 with the image conversion engine can be displayed in the format shown in FIG. 15. The database DB1 with the image conversion engine stores image data and the like that are necessary for the user support. More particularly, the database DB1 with the image conversion engine includes an image data ID, image data type, portable telephone model (or kind or type), personal computer model (or kind or type or model name), title, comments and the like. The database DB1 with the image conversion engine has a structure such that the image data showing the method of coping with the trouble in the easily understandable manner, for the input personal computer model, can be obtained (that is, output) with an appropriate format, such as the image size and the resolution, that conforms to (or suits) the input portable telephone model, when the user's portable telephone model and the personal computer model are input with respect to the database DB1 with the image conversion engine. For example, when the operator of the telephone operator terminal 5-12 clicks, by the mouse, the title column of the database DB1 with the image conversion engine, the corresponding image data is displayed on the display screen of the telephone operator terminal 5-12. In addition, when the operator of the telephone operator terminal 5-12 carries out an operation of attaching the displayed image data to the e-mail that is to be sent to the user, the displayed image data is attached to the e-mail.

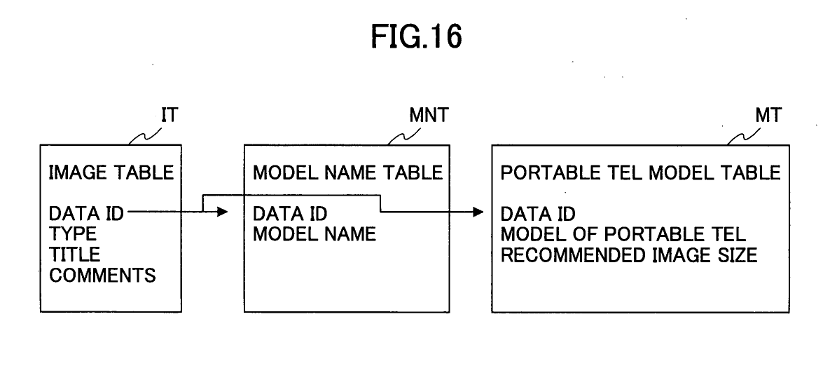

FIG. 16 is a diagram for explaining tables for storing the information of the database DB1 with the image conversion engine. FIG. 16 shows an image table IT, a model name table MNT, and a portable telephone model table MT. The image table IT includes an image data ID, image data type, title, comments and the like. The model name table MNT includes an image data ID, model name of the personal computer, and the like. The portable telephone model table MT includes an image data ID, portable telephone model, recommended image size and the like. The database DB1 with the image conversion engine stores the contents of the image table IT, the model name table MNT and the portable telephone model table MT in a linked manner as indicated by arrows in FIG. 16.

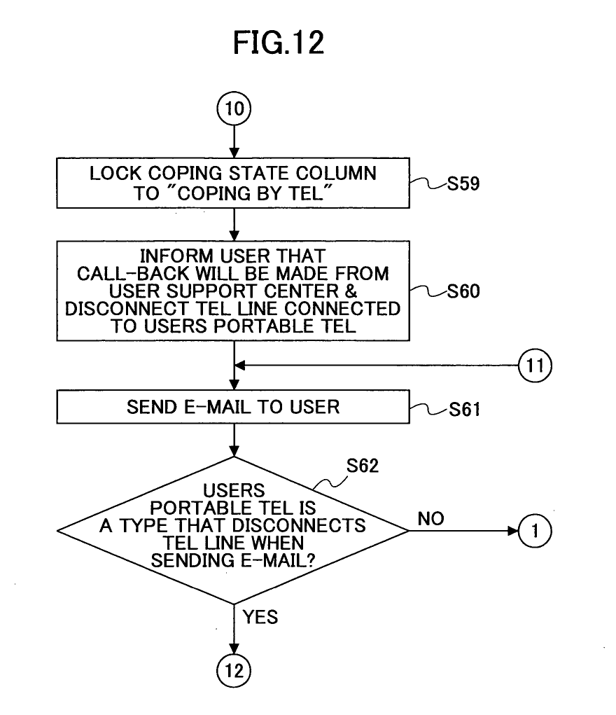

Returning now to the description of FIG. 11, in the step S58, the operator of the telephone operator terminal 5-12 confirms the portable telephone model column of the user registration database DB2 with respect to the user, and decides whether or not the portable telephone 8-1 is a type which disconnects the connected telephone line when sending the e-mail. If the decision result in the step S58 is NO, the process advances to a step S61 shown in FIG. 12 which will be described later. On the other hand, if the decision result in the step S58 is YES, the process advances to a step S59 shown in FIG. 12 which will be described later.

The steps S53 through S56 and S68 may be carried out automatically by the telephone operator terminal 5-12 under the control of the customer management database server 32.

In the step S59 shown in FIG. 12, the operator of the telephone operator terminal 5-12 locks the coping state column of the user registration database DB2 with respect to the user to “coping by telephone”. In a step S60, the operator of the telephone operator terminal 5-12 informs the portable telephone 8-1 of the user that a call-back will be made from the user support center 1 with respect to the user after receiving the e-mail from the user, and disconnects the telephone line that is connected to the portable telephone 8-1 of the user. In the step S61, the e-mail server 4 sends the e-mail for the portable telephone 8-1 of the user via the Internet 9. In the step S62, the operator of the telephone operator terminal 5-12 confirms the portable telephone model column of the user registration database DB2 with respect to the user, and decides whether or not the portable telephone 8-1 is a type which disconnects the connected telephone line when sending the e-mail. If the decision result in the step S62 is NO, the process returns to the step S7 shown in FIG. 5. If the decision result in the step S62 is YES, the process returns to the step S1 shown in FIG. 4.

The steps S59 and S62 may be carried out automatically by the telephone operator terminal 5-12 under the control of the customer management database server 32.

In the embodiment described above, the image data of the state of the trouble generated in the user's personal computer is picked up and sent to the user support center from the user's portable telephone, and in response thereto, the user support center sends the image data showing the method of coping with the trouble in the easily understandable manner to the user's portable telephone to be displayed on the display screen of the user's portable telephone. However, the present invention is not limited to the case where the portable telephone is used to send the image data to and from the user support center. For example, the image data may be sent to and from the user support center using various kinds of electronic apparatuses having an image pickup function for picking up an image (taking pictures) and a function for sending and receiving the image data (or an e-mail function), such as a portable (or lap-top) personal computers and PDA terminals, and such various kinds of electronic apparatuses desirably includes a telephone function.

In addition, the image data sent from the portable telephone to the user support center may be still images or, dynamic images or, a combination of still and dynamic images. Similarly, the image data sent from the user support center to the portable telephone may be still images or, dynamic images or, a combination of still and dynamic images. Moreover, the kind of image data (still images, dynamic images, combination of still and dynamic images) sent from the portable telephone to the user support centre does not necessarily be the same as the kind of image data sent from the user support center to the portable telephone, and the kind of image data sent from each end may be selected arbitrarily.

The telephone operator terminal group 5 and the e-mail operator terminal group 6 do not need to be completely independent of each other, and at least a part of the terminals may function as both the telephone operator terminal and the e-mail operator terminal, depending on the number of operators (support persons) and the like.

Further, the present invention is not limited to these embodiments, but various variations and modifications may be made without departing from the scope of the present invention.

1. A user support system comprising:
a receiving part including a plurality of user support windows configured to receive first image data showing a state of trouble generated in an information processing apparatus, from an electronic apparatus that is independent of the information processing apparatus; and
a sending part configured to send second image data showing a procedure for solving the trouble, to the electronic apparatus.

2. The user support system as claimed in claim 1, further comprising:
a part configured to issue and send a temporary address of a corresponding user support window, of the receiving part, to the electronic apparatus, based on user data obtained by user authentication.

3. The user support system as claimed in claim 2, wherein the receiving part automatically transfers the first image data to the user support window having the temporary address.

4. The user support system as claimed in claim 2, further comprising:
a part configured to invalidate the temporary address at an arbitrary timing after the sending part sends the second image data to the electronic apparatus.

5. The user support system as claimed in claim 2, further comprising:
a part configured to prohibit access to the user support window having the temporary address from an apparatus other than the electronic apparatus to which the temporary address is sent.

6. The user support system as claimed in claim 1, further comprising:
a database storing second image data showing procedures for solving a plurality of troubles for each model of the information processing apparatus; and
a reading part configured to read the second image data for the model of the information processing apparatus in which the trouble is generated, based on user data obtained by user authentication,
wherein the sending part sends to the electronic apparatus the second image data that is read from the database by the reading part.

7. The user support system as claimed in claim 6, wherein the reading part reads the second image data from the database with a format suited for a model of the electronic apparatus.

8. The user support system as claimed in claim 1, wherein the receiving part receives, by an electronic mail, the first image data that is picked up by the electronic apparatus.

9. The user support system as claimed in claim 1, wherein the sending part sends the second image data to the electronic apparatus by an electronic mail.

10. The user support system as claimed in claim 1, wherein:
the first image data is selected from a group consisting of still images, dynamic images, and a combination of still and dynamic images; and
the second image data is selected from a group consisting of still images, dynamic images, and a combination of still and dynamic images.

11. A user support method comprising:
a receiving step receiving, by one of a plurality of user support windows, first image data showing a state of a trouble generated in an information processing apparatus, from an electronic apparatus that is independent of the information processing apparatus; and
a sending step sending, from said one of the plurality of user support windows, second image data showing a procedure for solving the trouble, to the electronic apparatus.

12. The user support method as claimed in claim 11, further comprising:
a step issuing and sending a temporary address of said one of the plurality of user support windows, to the electronic apparatus, based on user data obtained by user authentication.

13. The user support method as claimed in claim 12, wherein the receiving step automatically transfers the first image data to said one of the plurality of user support windows having the temporary address.

14. The user support method as claimed in claim 12, further comprising:
a step invalidating the temporary address at an arbitrary timing after the sending step sends the second image data to the electronic apparatus.

15. The user support method as claimed in claim 12, further comprising:
a step prohibiting access to said one of the plurality of user support windows having the temporary address from an apparatus other than the electronic apparatus to which the temporary address is sent.

16. A computer-readable storage medium which stores a program for causing a computer to provide a user support via a plurality of user support windows, said program comprising:
a receiving procedure causing the computer to receive, by one of the plurality of user support windows, first image data showing a state of trouble generated in an information processing apparatus, from an electronic apparatus that is independent of the information processing apparatus; and
a sending procedure causing the computer to send, from said one of the plurality of user support windows, second image data showing a procedure for solving the trouble, to the electronic apparatus.

17. The computer-readable storage medium as claimed in claim 16, wherein said program further comprises:
a procedure causing the computer to issue and send a temporary address of said one of the plurality of user support windows, to the electronic apparatus, based on user data obtained by user authentication.

18. The computer-readable storage medium as claimed in claim 17, wherein the receiving procedure causes the computer to automatically transfer the first image data to said one of the plurality of user support windows having the temporary address.

19. The computer-readable storage medium as claimed in claim 17, wherein said program further comprises:
a procedure causing the computer to invalidate the temporary address at an arbitrary timing after the sending procedure causes the computer to send the second image data to the electronic apparatus.

20. The computer-readable storage medium as claimed in claim 17, wherein said program further comprises:
a procedure causing the computer to prohibit access to said one of the plurality of user support windows having the temporary address from an apparatus other than the electronic apparatus to which the temporary address is sent.

21. The computer-readable storage medium as claimed in claim 16, wherein said program further comprises:
a reading procedure causing the computer to read, from a database storing second image data showing procedures for solving a plurality of troubles for each model of the information processing apparatus, the second image data for the model of the information processing apparatus in which the trouble is generated, based on user data obtained by user authentication,
wherein the sending procedure causes the computer to send to the electronic apparatus the second image data which the reading procedure causes the computer to read from the database.

22. The computer-readable storage medium as claimed in claim 21, wherein the reading procedure causes the computer to read the second image data from the database with a format suited for a model of the electronic apparatus.

23. The computer-readable storage medium as claimed in claim 16, wherein the receiving procedure causes the computer to receive, by an electronic mail, the first image data that is picked up by the electronic apparatus.

24. The computer-readable storage medium as claimed in claim 16, wherein the sending procedure causes the computer to send the second image data to the electronic apparatus by an electronic mail.

25. The computer-readable storage medium as claimed in claim 16, wherein:
the first image data is selected from a group consisting of still images, dynamic images, and a combination of still and dynamic images; and
the second image data is selected from a group consisting of still images, dynamic images, and a combination of still and dynamic images.
